(19) United States
(12) Patent Application Publication
(10) Pub. No.: US 2007/0174137 A1
(43) Pub. Date: Jul. 26, 2007

(54) Purchasing method and purchasing system

(76) Inventors: Wen-Jung Hsueh, Tainan (TW); Chung-Yen Chen, Tainan (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/657,073

(22) Filed: Jan. 24, 2007

(30) Foreign Application Priority Data
Jan. 25, 2006 (TW) 095102860

(51) Int. Cl. G06Q 30/00

(52) U.S. Cl. 705/26

(57) ABSTRACT

The invention relates to a purchasing system and purchasing method. The purchasing system comprises a first setting device, a receiving device, a determining device and a first purchasing device. The first setting device is used for setting an article information and a participating information. The receiving device is used for receiving registering information from a plurality of participators. The determining device is used for determining at least one participator as a first purchaser from the participators. The first purchasing device is used for allowing the first purchaser to purchase the article at a first price. According to the purchasing system and method of the invention, the first purchaser can buy the article at a very low price to save the cost. The other participator can have fin of playing the activity (game or lottery etc.) and the right of buying the article during the purchasing period. Therefore, the purchasing system and method of the invention can excite the purchasing interest of the consumer and can gather the purchasing right of the consumer so as to promote circulation of the commercial purchasing activity.

### BACKGROUND OF THE INVENTION

1. Field of the Invention

The present invention relates to a purchasing system and purchasing method.

2. Description of the Related Art

According to the conventional internet purchasing method, the article information is shown on the website to receive the order from the customer. The article information comprise the brain, the model and the price and so forth, and the price of the article is fixed. The other conventional internet purchasing method is aggregative purchase method. The price of the article is set according to the number of the purchasers, and the number of the purchasers is increased so that the price of the article is decreased. For example, the number of the purchasers is 1-10 then the price of the article is 100 dollars; the number of the purchasers is 11-20 then the price of the article is 95 dollars; the number of the purchasers is 21-30 then the price of the article is 90 dollars, whereby the people are attracted to buy the article on the internet. The companies on the internet often spend a lot of money on advertisement and market to attract the people to buy the article. However, the people always surf on the internet. The conventional internet purchasing method cannot excite the people to buy the article on the internet, and there is no fun during the purchasing period so that the business of the internet companies are not good.

Therefore, it is necessary to provide a purchasing system and purchasing method so as to solve the above problem.

### SUMMARY OF THE INVENTION

One objective of the present invention is to provide a purchasing method. The purchasing method comprises the steps of: (a) setting an article information and a participating information; (b) receiving registering information from a plurality of participators; (c) determining at least one participator as a first purchaser from the participators; and (d) allowing the first purchaser to purchase the article at a first price.

Another objective of the present invention is to provide a purchasing system. The purchasing system comprises a first setting device, a receiving device, a determining device and a first purchasing device. The first setting device is used for setting an article information and a participating information. The receiving device is used for receiving registering information from a plurality of participators. The determining device is used for determining at least one participator as a first purchaser from the participators. The first purchasing device is used for allowing the first purchaser to purchase the article at a first price.

According to the purchasing system and method of the invention, the first purchaser can buy the article at a very low price to save the cost. The other participator can have fun of playing the activity (game or lottery etc.) and the right of buying the article during the purchasing period. Therefore, the purchasing system and method of the invention can excite the purchasing interest of the consumer and can gather the purchasing right of the consumer so as to promote circulation of the commercial purchasing activity.

### BRIEF DESCRIPTION OF THE DRAWINGS

FIG. 1 shows a flow chart of the purchasing method according to the invention.

FIG. 2 shows a block diagram of the purchasing system according to the invention.

### DETAILED DESCRIPTION OF THE INVENTION

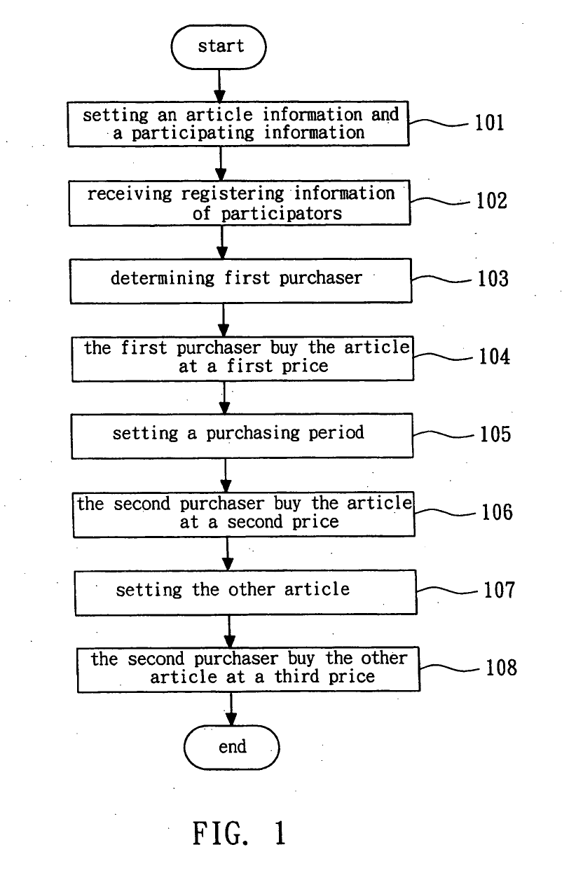

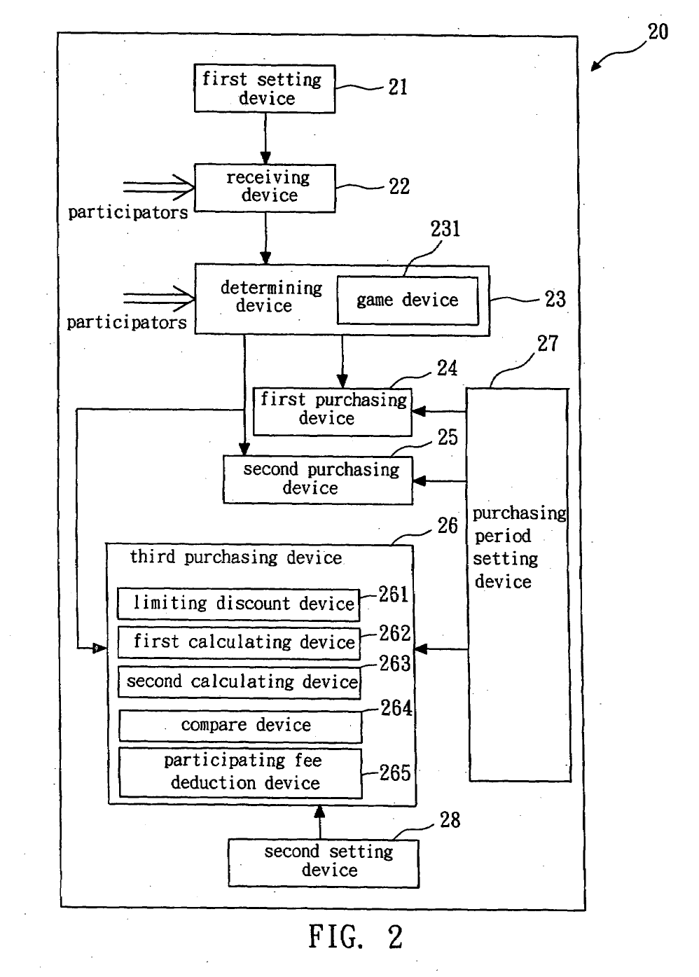

Referring to FIG. 1 and FIG. 2, according to the invention, the purchasing system and purchasing method can be applied to the internet purchase or the common commercial purchase. The purchasing system 20 of the invention comprises a first setting device 21, a receiving device 22, a determining device 23 and a first purchasing device 24. Referring to step 101 and FIG. 2, the first setting device 21 is used for setting an article information and a participating information. The article information comprises an article name and an article price, for example, the price of the article (W) is Y dollars. The article can be a physical article (for example, cup, computer or car etc.) or service (for example, SPA ticket or hotel ticket etc.) The participating information comprises the number of the participators and a participating fee, for example, the number of the participators is X, and the participating fee is Z dollars. The participating fee is set as Z≧Y/X, that is, the number of the participators (X) times the participating fee (Z) is larger than or is equal to the article price (Y). Preferably, the number of the participators times the participating fee is equal to the article price, that is, the participating fee is set as Z=Y/X.

Referring to step 102 and FIG. 2, the receiving device 22 is used for receiving registering information from a plurality of participators. The registering information comprises personal information and the participating fee, that is, the participators must pay the participating fee, and then the registering information is approved. Thus, the participators must have the will to buy the article, then register the personal information and pay the participating fee. In the embodiment of the invention, the purchasing system will not refund the participating fee to the participators, and the number of the participators must be the same as X.

Referring to step 103 and FIG. 2, the determining device 23 is used for determining at least one participator as a first purchaser from the participators. The determining device 23 comprises a game device 231 having a plurality of games, the participators play one of the games, for example the online game, to determine at least one winner, and the winner is the first purchaser. The determining device 23 can be a lottery device for determining at least one prizeman, and the prizeman is the first purchaser. However, the determining device 23 does not limit to the above game device or lottery device, and the determining device 23 must have equitable and public characteristics to let the participators and the people confide the purchasing system and method of the invention.

Referring to step 104 and FIG. 2, the first purchasing device 24 is used for allowing the first purchaser to purchase the article (W) at a first price. For example, if the first purchaser is an only one person, the first price is the participating fee (Z), that is, the first purchaser can buy the article at the participating fee paid before, and does not pay any expense. If the number of the first purchaser is N (N>1), the first price is M dollars (M=Y−Y/N). In this example, the first price M is larger than the participating fee Z. However, if the number of the first purchaser is N (N>1), the first price does not limit to be the above M dollars and the above calculating method, and the first price can also be the participating fee (Z).

Referring to step 105 and FIG. 2, the purchasing system 20 of the invention further comprises a purchasing period setting device 27 for setting a purchasing period, for example one week or one mouth. The first purchaser can buy the article at the first price during the purchasing period. The first purchaser can not buy the article beyond the purchasing period.

Referring to step 106 and FIG. 2, the purchasing system 20 of the invention further comprises a second purchasing device 25. The other participators are a second purchaser except the first purchaser, and the second purchaser can buy the article at a second price during the purchasing purchasing period. The second price is equal to the article price Y substrates the participating fee Z. For example, the second price is B dollars (B=Y−Z), that is, the second purchaser can further pay the second price B to buy the article W. Therefore, the participating fee Z paid before adds the second price B, the second purchaser buys the article W at the article price Y totally.

When the second purchaser does not want to buy the article W, the second purchaser can keep the participating fee paid before to consider to buy the other article provided in the purchasing system of the invention. Referring to step 107 and FIG. 2, the purchasing system 20 of the invention further comprises a second setting device 28 for setting the other articles except the article W, and each the other articles has an article price. For example, the other article is S, and the article price of the other article S is K dollars.

Referring to step 108 and FIG. 2, the purchasing system 20 of the invention further comprises a third purchasing device 26. The second purchaser can buy the other article S at a third price during the purchasing period. The article price of the other article S substrates a real discount Q is the third price. The third purchasing device 26 further comprises a limiting discount device 261 for setting a limiting discount L of the other article. The real discount Q is smaller than or equal to the limiting discount L. The real discount Q is calculated according to the participating fee or an accumulated participating fee.

That is, if the second purchaser participates many purchasing activities mentioned above, the second purchaser can accumulate the participating fee paid before. The third purchasing device 26 further comprises a first calculating device 262 for calculating an accumulated participating fee of the second purchaser. The accumulated participating fee is calculated accumulatively according to the participating fee of the second purchaser. The second purchaser can directly buy the other article or the promoted article published on the purchasing system without via the determining device.

Therefore, the real discount is calculated according to a real participating fee. The real participating fee T can be the participating fee Z before accumulated or the accumulated participating fee G after accumulated.

The third purchasing device 26 further comprises a second calculating device 263 for calculating a participating deduction according to a first rate and the real participating fee. For example, the first rate is F, and the participating deduction is V dollars, then the participating deduction is equal to the real participating fee times the first rate (V=T×F %). The third purchasing device 26 further comprises a compare device 264 for comparing the participating deduction and the limiting discount L. If the participating deduction is larger than the limiting discount (V>L), the real discount is set to be the limiting discount (Q=L). If the participating deduction is smaller than or equal to the limiting discount (V≦L), the real discount is set to be the participating deduction (Q=V). The second purchaser can pay the difference (K−Q) to buy the other article S.

The third purchasing device 26 further comprises a participating fee deduction device 265 for calculating a remainder real participating fee R according to the real participating fee. If the participating deduction is larger than the limiting discount (V>L), the remainder real participating fee is equal to that the real participating fee T substrates that the real discount Q is divided by the first rate F (R=T−Q/F). If the participating deduction is smaller than or equal to the limiting discount (V≦L), the remainder real participating fee is equal to zero (R=0).

The following description is a first example to further explain the above operation of the purchasing system and method of the invention. If the real participating fee of the second purchaser is the accumulated participating fee, for example 500 dollars, and the article price K of the other article S is 100 dollars, the limiting discount L is set to be 10 dollars. The first rate F is 5%, thus the participating deduction V is 25 dollars (500×5%). In this first example, because the participating deduction (V=25) is larger than the limiting discount (L=10), the real discount Q is set to be the limiting discount L (Q=L=10). The second purchaser can pay the difference 90 dollars (K−Q=100−10) to buy the other article S. The remainder real participating fee R is equal to that the real participating fee T substrates that the real discount Q is divided by the first rate F (R=T−Q/F). Therefore, after the real discount (Q=10) is deducted, the remainder real participating fee is 300 dollars (500−10/5%).

The following description is a second example to further explain the above operation of the purchasing system and method of the invention. If the real participating fee of the second purchaser is the participating fee without accumulated, for example 100 dollars, and the article price K of the other article S is 100 dollars, the limiting discount L is set to be 10 dollars. The first rate F is 5%, thus the participating deduction V is 5 dollars (100×5%). In this second example, because the participating deduction (V=5) is smaller than the limiting discount (L=10), the real discount is set to be the participating deduction (Q=V=5). The second purchaser can pay the difference 95 dollars (K−Q=100−5) to buy the other article S. Therefore, after the real discount (Q=5) is deducted, the remainder real participating fee is zero (100−5/5%).

Therefore, according to the purchasing system and method of the invention, the consumers wanted to buy the article can be attracted to join the purchasing system and method of the invention so as to determine the first purchaser by the determining device. The first purchaser can buy the article at a very low price to save the cost. The other participator (the second purchaser) can have fun of playing the activity (game or lottery etc.) and the right of buying the article during the purchasing period. Therefore, the purchasing system and method of the invention can excite the purchasing interest of the consumer and can gather the purchasing right of the consumer so as to promote circulation of the commercial purchasing activity.

The purchasing system and method of the invention can gather the purchasing ability of the consumer, a few purchasers (the first purchaser) can buy the article at a very low price in every purchasing activity. As to the purchasing system and method of the invention, according to the price of the article to calculating the number of the participators and the participating fee, although the first purchaser can buy the article at a very low price, the profit of the purchasing system and method of the invention will be good when the more second purchaser buy the article. Therefore, as a whole, the purchasing system and method of the invention can have the profit at a certain level.

Furthermore, the purchasing system and method of the invention can be applied to the conventional commercial business or the modern electronic commerce so as to effectively gather the companies to sell the article. Therefore, the small company can have business, and the situation of causing the small company to close owing to only the big company or big internet company having business will not occur.

While an embodiment of the present invention has been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. A purchasing method, comprising the steps of:
(a) setting an article information and a participating information;
(b) receiving registering information from a plurality of participators;
(c) determining at least one participator as a first purchaser from the participators; and
(d) allowing the first purchaser to purchase the article at a first price.

2. The purchasing method according to claim 1, wherein the article information comprises an article name and an article price, the participating information comprises the number of the participators and a participating fee.

3. The purchasing method according to claim 2, wherein the number of the participators times the participating fee is larger than or is equal to the article price.

4. The purchasing method according to claim 2, in step (d), the first price is larger than or is equal to the participating fee.

5. The purchasing method according to claim 1, in step (c), at least one winner is determined by using a game, the winner is the first purchaser.

6. The purchasing method according to claim 1, the step (d) further comprises a step of setting a purchasing period, wherein the first purchaser can buy the article at the first price during the purchasing period.

7. The purchasing method according to claim 1, the step (d) further comprises a second purchasing step, wherein except the first purchaser the other participators are a second purchaser, and the second purchaser can buy the article at a second price during the purchasing period.

8. The purchasing method according to claim 7, wherein the article price substrates the participating fee is the second price.

9. The purchasing method according to claim 6, further comprising a step of setting the other articles, each the other articles has an article price.

10. The purchasing method according to claim 9, the step (d) further comprises a third purchasing step, wherein except the first purchaser the other participators are a second purchaser, and the second purchaser can buy the other article at a third price during the purchasing period.

11. The purchasing method according to claim 10, wherein the article price of the other article substrates a real discount is the third price.

12. The purchasing method according to claim 11, after the step (d) further comprising the steps of:
(e) setting a limiting discount of the other article;
(f) calculating a real participating fee of the second purchaser;
(g) calculating a participating deduction according to a first rate and the real participating fee;
(h) comparing the participating deduction and the limiting discount;
(i) setting the real discount being the limiting discount, and calculating a remainder real participating fee being that the real participating fee substrates that the real discount is divided by the first rate, if the participating deduction is larger than the limiting discount; and
(j) setting the real discount being the participating deduction, and calculating the remainder real participating fee being zero, if the participating deduction is smaller than or is equal to the limiting discount.

13. A purchasing system, comprising:
a first setting device, for setting an article information and a participating information;
a receiving device, for receiving registering information from a plurality of participators;
a determining device, for determining at least one participator as a first purchaser from the participators; and
a first purchasing device, for allowing the first purchaser to purchase the article at a first price.

14. The purchasing system according to claim 13, wherein the article information comprises an article name and an article price, the participating information comprises the number of the participators and a participating fee.

15. The purchasing system according to claim 14, wherein the number of the participators times the participating fee is larger than or is equal to the article price.

16. The purchasing system according to claim 14, the first price is larger than or is equal to the participating fee.

17. The purchasing system according to claim 13, the determining device comprises a game device having a plurality of games, the participators play one of the games to determine at least one winner, the winner is the first purchaser.

18. The purchasing system according to claim 14, further comprising a purchasing period setting device for setting a purchasing period, wherein the first purchaser can buy the article at the first price during the purchasing period.

19. The purchasing system according to claim 18, further comprising a second purchasing device, wherein except the first purchaser the other participators are a second purchaser, and the second purchaser can buy the article at a second price during the purchasing period.

20. The purchasing system according to claim 19, the article price substrates the participating fee is the second price.

21. The purchasing system according to claim 18, further comprising a second setting device for setting the other articles, each the other articles has an article price.

22. The purchasing system according to claim 21, further comprising a third purchasing device, wherein except the first purchaser the other participators are a second purchaser, and the second purchaser can buy the other article at a third price during the purchasing period.

23. The purchasing system according to claim 22, the article price of the other article substrates a real discount is the third price.

24. The purchasing system according to claim 23, wherein the third purchasing device further comprises:
a limiting discount device, for setting a limiting discount of the other article;
a first calculating device, for calculating a real participating fee of the second purchaser;
a second calculating device, for calculating a participating deduction according to a first rate and the real participating fee;
a compare device, for comparing the participating deduction and the limiting discount, and setting the real discount being the limiting discount if the participating deduction is larger than the limiting discount, and setting the real discount being the participating deduction if the participating deduction is smaller than or is equal to the limiting discount; and
a participating fee deduction device, for calculating a remainder real participating fee being that the real participating fee substrates that the real discount is divided by the first rate.
